(19) United States
(12) Patent Application Publication
(10) Pub. No.: US 2023/0053147 A1
(43) Pub. Date: Feb. 16, 2023

(54) INSTALLATION FRAME OF AN EXHAUST BLOWER OF A BUILDING AND EXHAUST AIR CONTROL SYSTEM

(71) Applicant: ENTOS Energiatekniikan Optimisäätö Oy, Mikkeli (FI)

(72) Inventor: Aki POHJALAINEN, Mikkeli (FI)

(21) Appl. No.: 17/794,105

(22) PCT Filed: Feb. 17, 2021
(86) PCT No.: PCT/FI2021/050113

§ 371 Date: Jul. 20, 2022

(30) Foreign Application Priority Data
Feb. 19, 2020 (FI) U20204031

(51) Int. Cl. F24F 7/02; F24F 11/77; F24F 13/08; F24F 11/61

(52) U.S. Cl. CPC F24F 7/025; F24F 11/77; F24F 13/08; F24F 11/61; F24F 2013/205

(57) ABSTRACT

In the solution put forth, there is a frame structure (122) and an inner surface structure (124) in an installation frame (110) of an exhaust blower (108) of a building (100). A bottom part (130) of the frame structure is intended to be installed towards a lead-through (106) of the building, and a top part (132) towards the exhaust blower installed over it. The frame structure surrounds the inner surface structure so that it does not cover bottom and top parts (126, 128) of the inner surface structure. The inner surface structure forms a suction channel (134) allowing exhaust air (114) flow through the frame. Inside the installation frame, a controller (112) has been installed, adapted to measure the exhaust air flowing in the suction channel and to generate, on the basis of the measurement, a control command for the exhaust blower to control the operation of the exhaust blower.

### FIELD OF TECHNOLOGY

The application generally relates to an installation frame of an exhaust blower of a building and exhaust air control system.

### BACKGROUND

From the 1960s to 2000s, the most popular ventilation system for buildings, such as apartment buildings, has been blower-forced exhaust ventilation.

In a blower-forced exhaust ventilation systems of apartment buildings, room air is removed by means of an exhaust blower, installed in connection with an exhaust air channel, through exhaust air valves in the apartments to the exhaust air channel in which the air removed from indoor spaces is led to the roof of the apartment building and out of the apartment building.

Exhaust blowers are installed either directly over a lead-through of an exhaust air channel, made on the roof, or by using an installation frame which is adapted between the lead-through and exhaust blower and which facilitates installation.

As an exhaust blower is removing air from apartments, an underpressure forms in them whereby due to the underpressure the fresh air replacing the air being re-moved enters the apartments either controllably through fresh air valves or uncontrollably through the structures of the apartment building.

The exhaust blowers usually operate at two speeds and with clock control. In this case, the timer-controlled exhaust blower operates either on half or full power depending on the estimated utilisation rate of the apartment building.

### SUMMARY

An object of the invention is to solve prior art problems and establish a safe installation frame for an exhaust blower and an easily serviceable controller to connect to the exhaust blower, which allows “non-intelligent” exhaust blowers to be converted into intelligent ones. Due to the intelligence added to an exhaust blower, it is possible to implement appropriate ventilation on the basis of measurement data indicated by sensors, whereby e.g. wasting heat energy through ventilation is prevented, comfort of living is increased, safety in the apartments is enhanced, the feeling of draught is removed from the apartments, night-time ventilation in summer is made possible in the apartments, fire safety is increased, and mechanical noise from exhaust blowers is eliminated.

An object of the invention is achieved with an installation frame and control system according to the independent claims.

Embodiments of the invention include the installation frame and control system according to the independent claims.

An installation frame of an exhaust blower of a building, according to an embodiment of the invention, has a frame structure and inner surface structure. A bottom part of the frame structure is intended to be installed towards the lead-through of a building, and a top part towards the exhaust blower installed over it. The frame structure surrounds the inner surface structure so that it does not cover the bottom and top parts of the inner surface structure. The inner surface structure forms a suction channel allowing exhaust air flow through the frame. Inside the installation frame, a controller has been installed, adapted to measure the exhaust air flowing in the suction channel and to generate, on the basis of the measurement, a control command for the exhaust blower to control the operation of the exhaust blower.

A building's exhaust air control system according to an embodiment of the invention has at least one exhaust blower, an installation frame according to the embodiment described in the above connected to each exhaust blower, and a control server communicating with each frame through a communications network.

Other embodiments of the invention are disclosed in dependent claims.

### BRIEF DESCRIPTION OF THE FIGURES

Exemplary embodiments of the invention are described in closer detail with reference to the following figures:

FIG. 1a shows an exhaust blower installed on a roof of a building by means of a one-piece installation frame

FIG. 1b is a top view of a cross section of a two-piece installation frame, and parts of a controller with a side surface structure of the inner frame structure removed, as seen from a side

FIG. 1c shows an inner frame structure of a two-piece frame pulled out from an outer frame structure

FIG. 1d is a side view of a cross section of an exhaust blower installed on the roof by using a frame, and

FIG. 2 shows functional parts of a frame connected to an exhaust blower.

### Detailed description of the figures

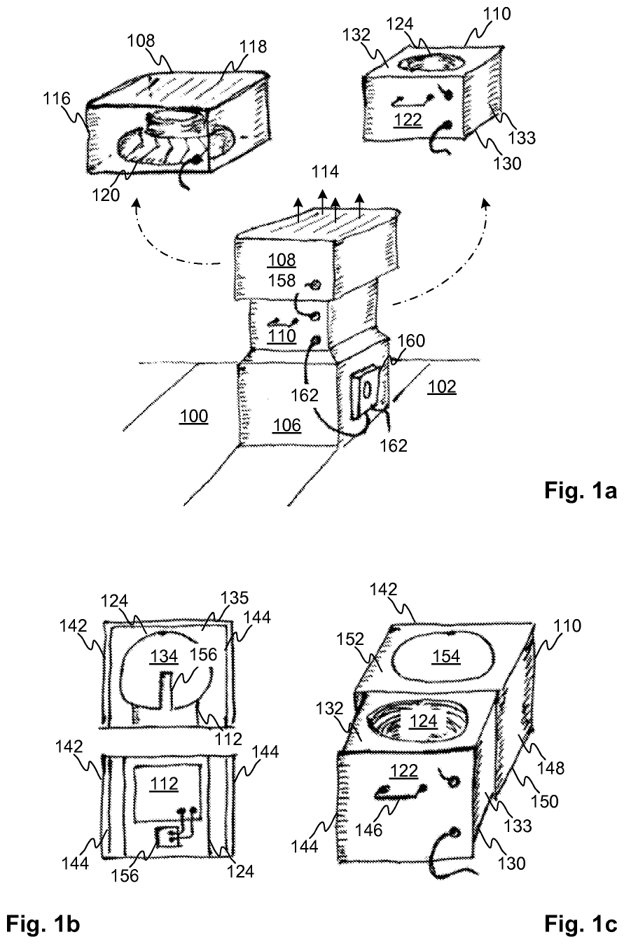

FIG. 1a to 1d show an exhaust blower (extractor blower) 108 to be installed in a lead-through (lead-through pipe, chimney) 106 of an exhaust air channel 104, made on a roof 102 of a building 100, e.g. an apartment building or a terraced house, and an installation frame 110 used for installing it, by means of a controller (controller unit) 112 included in it the blower 108 has been upgraded intelligent.

The blower 108 is installed by means of the frame 110 to an end of the exhaust air channel 104, brought from the indoor space of the building 100 through its roof structures to the roof 102, whereby the air 114 to be removed exits the building 100 through the frame 110 and blower 108.

In the blower 108 of the figure, the exhaust air 114 exits a cover frame (exit splitter) 116 through air openings 118 at its top part, but other options, too, exist to lead exhaust air 114 out of the blower 108 according to the blower type.

The purpose of the frame 110 is to make the blower 108 easier to install and to modernize it intelligent by means of the controller 112 so that the controller 112 makes decisions on how a blower motor 120 of the blower 108 is to operate on the basis of the measurement data it has acquired, and to send control (adjustment) commands CO it has generated to it.

The frame 110 includes a frame structure 122 and inner surface structure 124 that the frame structure 122 surrounds, as shown in the figures, so that it does not cover the bottom and top parts 126, 128 of the inner surface structure 124.

As per the figures, the profile of the frame structure 122 is a square, but alternatively it may be a rectangle, cylinder, or another shape. Irrespective of the profile form, the bottom part 130 of the frame structure 122 is intended to be installed towards the lead-through 106, and the top part 132 towards the blower 108 installed over it.

The inner surface structure 124 forms a suction channel 134 in the frame 110, which begins at the bottom part 126 of the inner surface structure 124 and ends at its top part 128. The suction channel 134 makes it possible for the exhaust air 114 from the exhaust air channel 104 to flow through the frame 110 to the blower 108.

As shown in the figures, the profile of the side surface structure 124 is a circle (round) but it may alternatively be of the shape of an oval (ellipse), square, rectangle, polygon, or another shape.

The frame structure 122 additionally includes a side part 133 which, together with the bottom part 130, top part 132, and the outer surface of the inner surface structure 124, facing the side part 133, define an encased space where the controller 112 is installed.

Installing the frame 110 and blower 108 to the lead-through 106 takes place by first installing a seal (seals) 136 at the top edge of the lead-through 106 as shown in the figures, and then adapting the frame 110 over the seal(s) 136 so that the interface between the top edge of the lead-through 106 and the bottom part 130 of the frame 110 becomes leak-proof, and the exhaust air 114 is able to flow to the suction channel 134 from the lead-through 106. The frame 110 is fixed to the lead-through 106 with fastening means (not shown in the figures), such as screws, bolts, screws or bolts fixed to nuts, or other appropriate fastening means.

Following the fastening of the frame 110, a seal (seals) 138 is next installed at the top part 132 of the frame 110 as shown in the figures, and then adapting an installation collar 140 to the cover frame 116 of the blower 108 over the seal(s) 138 so that also the interface between the top part 132 and the installation collar 140 becomes leak-proof, and the exhaust air 114 is able to flow from the suction channel 134 to the blower 108. The blower 108 is again fixed to the frame 110 with appropriate fastening means.

The frame 110 may alternatively comprise, unlike in the one-piece structure described in the above, a two-piece structure in which it additionally includes an outer frame structure (outer frame body) 142, where the frame's 110 inner frame structure (inner frame body) 144, now formed by the frame structure 122 and inner surface structure 124, is installable in a detachable manner. The task of the outer frame structure 142 is to protect the inner frame structure 144 against mechanical impacts and weather effects.

In addition, the task of the outer frame structure 142 is to allow the pulling out of the inner frame structure 144 from the frame 110 by means of a draw handle 146 it has, through an opening in the side part 148 of the outer frame structure 142, for repairs or maintenance.

The outer frame structure 142 surrounds the inner surface structure 144, as shown in the figures, so that it does not cover the bottom and top parts 126, 128 of the inner surface structure 124 of the inner frame structure 144, so those of the suction channel 134. This is implemented by forming openings 154 of the top and bottom part 150, 152 of the outer frame structure 142.

As seen in the figures, the profile of the outer frame structure 142 is a square, but alternatively it may be a rectangle, cylinder, or another shape. Irrespective of the profile form, the bottom part 150 of the outer frame structure 142 is intended to be installed against the lead-through 106, and the top part 152 for its part allows the blower 108 to be installed over it. Similarly, when the inner frame structure 144 is detachably installed inside the frame 110, its bottom part 130 sets against the inner surface of the bottom part 150 of the outer frame structure 142, its top part 132 against the inner surface of the top part 152 of the outer frame structure 142, and at least part of its side part 133 against the inner surface of the side part 148 of the outer frame structure 142. The part of the side part 133 of the inner frame structure 144, which does not set against the inner surface of the outer frame structure 142, forms, together with the side part 148 of the outer frame structure 142, an outer shell of the frame when the inner frame structure 144 is installed into the frame 110. The draw handle 146 is fixed to the side part 133 of the inner frame structure 144, acting as part of the outer shell.

Installing the two-piece frame 110 to the lead-through 106 takes place in the same way as that of the one-piece frame 110 described in the above. Installing takes place by adapting the frame 110 over the seal(s) 136 so that the interface between the top edge of the lead-through 106 and the bottom part 150 of the outer frame structure 142 of the frame 110 becomes leak-proof, and the exhaust air 114 is able to flow to the suction channel 134 from the lead-through 106. After this, the seal (seals) 138 is installed at the top part 152 of the outer frame structure 142 of the frame 110, and an installation collar 140 is adapted to the cover frame 116 of the blower 108 over the seal(s) 138 so that also the interface between the top part 152 and the installation collar 116 becomes leak-proof, and the exhaust air 114 is able to flow from the suction channel 134 to the blower 108. The frame 110 and blower 108 are fastened with appropriate fastening means.

The cover frame 116 of the blower 100 and the frame structures 122, 142, 144 of the frame 110 have the task of protecting the mechanical parts in them against mechanical impacts and weather effects. As their manufacturing material, thin plate is used, which is of aluminium and/or steel, for example.

The controller 112, regardless of whether the frame 110 is one-piece or two-piece, is detachably fixed to the frame structure 122 in the space 135, making its maintenance and repairs easy.

The controller 112 has a protruding air inlet duct 156, formed on a rear surface intended to face the outer surface of the inner surface structure 124, intended for installation inside the inner surface structure 124, that is, in the suction channel 134, for which there is an opening (not shown in the figures) in the inner surface structure 124 to push the air inlet duct 156 inside the inner surface structure 124. With the aid of the air inlet duct 156, part of the exhaust air 114 coming in the suction channel 134 is led inside the controller 112 where the sensors of its sensor part 264 are able to take measurements of it. Based on the measurement results, the controller 112 is able to estimate, based on the value and behaviour of the variable being measured, its effect on the need to control the motor 120. On the basis of the analysed control need, the controller 112 is then able to generate a control command CO sent to the motor 120.

The air inlet duct 156 is a hollow, e.g. tubular, rectangular, or polygonal channel, having in its bottom surface an air inlet through which the analysed exhaust air 114 taken (captured) from the exhaust air stream 114 can be led to the air inlet duct 156 and through it inside the controller 112. The controller 112 has a discharge opening to remove the analysed air from the controller 112 and back to the suction channel 134.

As shown in the figures, the air inlet duct 156 may comprise one or more air inlet channels according to the application, such as two, three, four, or five air inlet ducts 156.

From the controller 112, it is further possible to run measuring pipes along the suction channel 134, which are used for measuring e.g. a pressure difference between a suction chamber and air horn of the blower 108, a first one of which is located to measure a suction pressure of the suction chamber and a second one of which to measure the suction pressure of the air horn.

The controller 112 is connected to the motor 120 by means of a control connection cable (control cable) 158, brought out of the frame 110 and taken on the outside to the blower 108, and to a voltage supply through a safety switch 160 by means of a voltage supply cable 162 brought out of the frame 110, as in the figures.

The controller 112 further includes a temperature sensor for measuring the outdoor temperature and a pressure sensor for measuring the outdoor air pressure, included in the sensor part 264 and brought out of the frame 110.

The controller 112 is enclosed in a protective casing in the space 135 so that it stays operational. The protective casing keeps the controller 112 adequately warm or cool, in accordance with the outdoor weather conditions, as well as dry enough, and protects the controller 112 against the effects of the weather and dirt, as well as against mechanical impacts. The manufacturing material of the protective casing is plastic or metal, for example.

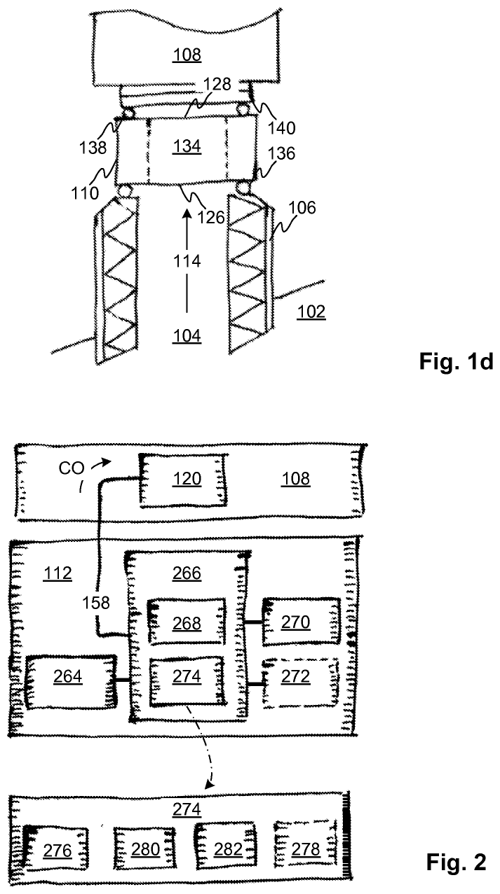

FIG. 2 shows functional parts 264, 266, 268, 270, 272, 274 of the controller 112 connected to the blower 108.

Inside a protective frame 116 of the blower 108, a motor 120 has been installed, whose task it is to draw the air 114 being removed from apartments to the exhaust air channel 104 and along it through a chimney 106 acting as the lead-through installed in the lead-through opening and the suction channel 134 of the frame 110 to the blower 108 where the motor 120 the blows the air 114 to be removed through the structure of the blower 108 out of the building 100. The motor 120 is installed at the centre of the space delimited by the structures of the protective frame 116.

The controller's 112 task is to make the blower 108 intelligent by analysing, on the basis of a measurement of at least one sensor in the sensor part 264 available to it, the need for control of the motor 120 and, when required, to control the operation of the motor 120 based on the analysis.

The control part 266, the sensor part 264 used as a control aid, and other functional parts 268, 270, 272, 274 are installed inside the protective casing of the controller 112. The control part 266 is connected to the motor 120 by means of the connecting cable 158.

The purpose of control automation of the control part 266 intended to control the motor 120 is to adjust the power of the motor 120 by generating control commands CO based on the measurement of at least one sensor in the sensor part 264.

The control part 266 includes a processor part 268 by means of which commands defined by a user or an application program are implemented, and data is processed.

The sensor part 264 has at least one sensor, based on whose measurement from the exhaust air 114 coming in the suction channel 134 the automation of the control part 266 adjusts the operation of the motor 120. With the at least one sensor of the sensor part 264, measurements may be performed also from the outdoor air surrounding the frame 112. The sensor part 264 includes at least one of the following sensors: a temperature sensor measuring the exhaust air temperature, a temperature sensor measuring outdoor air temperature, a humidity sensor measuring the exhaust air humidity, a sensor measuring the carbon dioxide content of the exhaust air, a sensor measuring the VOC gas content of the exhaust air, a sensor measuring outdoor pressure, and sensors measuring the suction pressures of the exhaust air, whose measuring pipes are taken on the inside of the blower's 108 protective frame 116 and by means of the measurement data produced by which an amount of air may also be defined.

The controller 112 additionally has a data transfer part 270 by means of which the controller 112 receives data from outside the frame 110 (controller 112) on a wireless data transmission connection and sends data outside on the wireless connection. The data transfer part 270 comprises e.g. a wireless 3G/4G network part by means of which the controller 112 communicates with a device external to the frame 110.

The controller 112 may have a physical user interface part 272 by means of which a user may enter commands and information, and/or receive information. The user interface part 272 is e.g. a communications interface to which it is possible to connect, with a connection cable, e.g. an external computer, a user interface provided with a display and keyboard, or a smart device having a touch screen.

Alternatively, a user may enter commands and data, and/or receive data with the terminal device (not shown in the figures), such as a smart phone, tablet computer, laptop computer, desktop computer or similar, and with a control software stored on it through the data transfer part 270 and at least one telecommunications net work. If the terminal device is a mobile terminal, such as the aforementioned smart phone, tablet computer, laptop computer, or similar, a user is able to control the controller 112 also by the data transfer part 270 and a short-range radio link.

Alternatively, the controller 112 is able to gather information relating to local weather, air quality, bulletins conveyed by emergency services, or similar, by means of the data transfer part 270 in a telecommunications network, such as the internet, and control the motor 120 operation based on the measurements performed by the sensor part 264 and additionally based on the information obtained from the telecommunications network. For example, if the local temperature rises high, pollution of the outdoor air increases, or as a result of a major fire indicated in an emergency services bulletin, the controller 112 may control the motor 120 to reduce or increase power.

The controller 112 additionally has a memory part 274 to save and store applications and data. The memory part 274 may comprise at least one memory, e.g. one, two, or three memories.

The memory part 274 has stored on it a data transfer application 276 controlling the operation of the data transfer part 270, the user interface part 272 being a user interface application 278 controlling its operation, an analysis application 280 intended to process data from the sensor part 264, and a control application 282 meant to control the operation of the motor 120.

The internal data transfer between the various parts 264, 266, 268, 270, 272, 274 required by the controller 112 is implemented on a fixed cable connection.

The memory part 274 has stored in it predetermined threshold values for each variable to be measured, and when the measurement data from a sensor indicates a threshold value having been exceeded, the analysis application 280 determines whether it needs to control the operation of the motor 120. The threshold values determine whether the motor 120 power (rotation speed) is still kept the same, reduced, or increased.

For example, it is possible to pre-determine threshold values for temperature so that if the temperature of the exhaust air 114 falls below 20° C., the controller 112 controls the motor 120 to reduce power so that the draught is reduced in the apartments of the building 100. If, on the other hand, the exhaust air 114 temperature exceeds 23° C., the controller 112 controls the motor 120 to increase power to boost ventilation, and if the exhaust air temperature is in the range 20 to 23° C., the current motor 120 power is maintained. A similar approach applies to other variables being measured. In addition, the controller 112 is able to deduce the need to boost or decrease ventilation on the basis of the measurement data of two or more measurement variables, based on the pre-determined threshold values.

In addition, the analysis application 280 is able to determine the need for ventilation based on the measurement data of two or more variables being measured. For example, the analysis application 280 is able to detect a fire in the building 100 from the exhaust air 114, by analysing the measurement data from the VOC, carbon dioxide, g5temperature, and humidity sensors, and based on the analysis, the controller 112 controls the motor 120 to intensify operation to remove smoke. In addition, the controller 112 may, having noticed a fire, wirelessly provide the data transfer part 270 with information on it, in other words, set off a fire alarm, to a second external terminal device.

The operation of the blower 108 may be monitored in real time and/or controlled on a wireless telecommunication connection (network) by using a terminal device with a browser-based control software meant for controlling the blower 108, as described in the above. By the use of the control software on a terminal device, it is possible to monitor the operation of the blower 108, or that of a plurality of blowers 108, by examining measurement data received from different sensors of each controller 112 and the analysis data made based on this, to receive notifications, such as a fire alarms, and to control manually the operation of the blower(s) 108.

The exhaust air system of an entire big building 100, having a plurality of blowers 108 upgraded with the controller 112 of the frame 110 may be so arranged that the controllers 112 communicate among themselves wirelessly by means of the data transfer part 270, one of the controllers 112 acting as the master controller through which all the other controllers 112 send information through at least one telecommunications network to an external terminal device, such as a control server (not shown in the figures). Through the master controller 112, all the other controllers 112 also receive incoming data, by means of which they are controlled, through at least one telecommunications network.

The control server is able to gather information relating to local weather, air quality, bulletins conveyed by emergency services, or similar, by means of the control software in a telecommunications network(s), such as the internet, and control the exhaust air system based on the information obtained from them. Based on information obtained e.g. from a telecommunications network concerning a rise in the local outdoor temperature, pollution outdoors, or an emergency services bulletin, the control server may control, through the master controller 112, each controller 112 of the exhaust air system to reduce or increase the motor 120 power.

1. An installation frame of an exhaust air blower of a building having
a frame structure and
an inner surface structure.
a bottom part of the frame structure being intended to be installed towards a lead-through of a building, and a top part towards an exhaust blower installed over it.
the frame structure surrounding the inner surface structure so that it docs not cover bottom and top parts of the inner surface structure, and
the inner surface structure forming a suction channel allowing exhaust air flow through the frame, wherein
inside the installation frame, a controller has been installed, adapted to measure the exhaust air flowing in the suction channel and to generate, on the basis of the measurement, a control command for the exhaust blower to control the operation of the exhaust blower.

2. An installation frame as claimed in claim 1, wherein the frame structure and inner surface structure form an inner frame structure, and the installation frame additionally has an outer frame structure protecting the inner frame structure and formed around it. without covering the bottom and top parts of the inner surface structure, the inner frame structure being detachably installed to the outer frame structure.

3. An installation frame as claimed in claim 2, wherein the bottom part of the outer frame structure is intended to be installed against a building's lead through, and its top part allows the installation of the exhaust blower against it, whereby the bottom part of the inner frame structure installed in the installation frame sets against the inner surface of the bottom part of the outer frame structure, its top part against the inner surface of the top part of the outer frame structure, and at least part of its side part against the inner surface of the side part of the outer frame structure.

4. An installation frame as claimed in claim 1, wherein the controller has a control part adapted to communicate with the various parts of the controller, and with devices external to the installation frame through a telecommunications network: a sensor part whose at least one sensor is adapted to measure the exhaust air flowing through the suction channel of the installation frame: and a control part adapted to send, on the basis of a measurement by at least one sensor, a control command controlling the operation of a blower motor of the exhaust blower.

5. An installation frame as claimed in claim 4, wherein the inner surface structure has an air inlet duct protruding therefrom and installed inside the suction channel, and by means of which part of the exhaust air coming in the suction channel is led to the controller for an analysis part to analyse.

6. An installation frame as claimed in claim 5, wherein the bottom surface of the air inlet duct has an air inlet to lead the exhaust air to be analysed inside the controller through the air inlet duct, and the controller has a discharge opening to remove the analysed air from the installation frame to the suction channel.

7. A building's exhaust air control system having at least one exhaust blower, wherein an installation frame according to claim 1 is in the system connected to each exhaust blower, and a control server is communicating with each installation frame through a communications network.
